(19) United States
(12) Patent Application Publication
(10) Pub. No.: US 2024/0079189 A1
(43) Pub. Date: Mar. 7, 2024

(54) SWITCH AND ON-LOAD TAP CHANGER WITH A SWITCH

(71) Applicant: Maschinenfabrik Reinhausen GmbH, Regensburg (DE)

(72) Inventors: Christian Hammer, Regensburg (DE); Simon Flotzinger, Aufhausen (DE)

(21) Appl. No.: 18/261,671

(22) PCT Filed: Feb. 9, 2022
(86) PCT No.: PCT/EP2022/053057

§ 371 Date: Jul. 17, 2023

(30) Foreign Application Priority Data
Mar. 2, 2021 (DE) 10 2021 104 923.7

(51) Int. Cl. H01H 9/00; H01H 1/54

(52) U.S. Cl. CPC H01H 9/0016; H01H 1/54; H01H 9/0044; H01H 2001/545

(57) ABSTRACT

A switch can be used for an on-load tap changer. The switch includes: fixed contacts, including a first fixed contact and a second fixed contact; and a moving contact with a first attraction element. The moving contact is movable from a first position into a second position via the first attraction element and a second attraction element, which is arranged outside the switch. The moving contact is configured such that, in the first position, the moving contact contacts neither or only one of the fixed contacts and, in the second position, the moving contact contacts both of the fixed contacts.

### CROSS REFERENCE TO RELATED APPLICATIONS

This application is a U.S. National Phase application under 35 U.S.C. § 371 of International Application No. PCT/EP2022/053057, filed on Feb. 9, 2022, and claims benefit to German Patent Application No. DE 10 2021 104 923.7, filed on Mar. 2, 2021. The International Application was published in German on Sep. 9, 2022 as WO 2022/184389 A1 under PCT Article 21(2).

### FIELD

The present disclosure relates to a switch for an on-load tap changer. The present disclosure also relates to an on-load tap changer with a switch.

### BACKGROUND

On-load tap-changers usually have a diverter switch and a selector. Vacuum interrupters are usually installed in maintenance-free diverter switches for switching under load. Vacuum interrupters have only low contact wear, which is advantageous in particular in the case of high cut-off currents. The rapid re-solidification of the switching path is advantageous in particular in the case of high recovery voltages. A disadvantage of vacuum interrupters is that the actuation force required for their actuation is heavily dependent on the external pressure, which can change significantly, in particular, in the case of hermetic transformers. In addition, vacuum interrupters are relatively expensive. In particular, in the case of transformers with small load currents and step voltages, the advantageous properties of the vacuum interrupters are not necessary, while the disadvantages remain.

### SUMMARY

In an embodiment, the present disclosure provides a switch that can be used for an on-load tap changer. The switch includes: fixed contacts, including a first fixed contact and a second fixed contact; and a moving contact with a first attraction element. The moving contact is movable from a first position into a second position via the first attraction element and a second attraction element, which is arranged outside the switch. The moving contact is configured such that, in the first position, the moving contact contacts neither or only one of the fixed contacts and, in the second position, the moving contact contacts both of the fixed contacts.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a first view of a switching means according to the present disclosure;

FIG. 2 shows a further view of the switching means according to the present disclosure;

FIG. 3 shows a further view of the switching means according to the present disclosure;

FIG. 4 shows a first sectional view of the switching means according to the present disclosure;

FIG. 5 shows a second sectional view of the switching means according to the present disclosure;

FIG. 6 shows an on-load tap changer according to the present disclosure with at least one switching means; and

FIG. 7 shows a detailed view of an on-load tap changer with a switching means.

### DETAILED DESCRIPTION

The present disclosure creates a switching means for on-load tap changers that is of simple and compact construction, is suitable particularly for on-load tap changers for small load currents and step voltages, and in which the force required for the actuation of the switching means is independent of the external pressure.

The present disclosure creates an on-load tap-changer with a switching means that is of a simple, compact, and economical construction.

The present disclosure provides, according to a first aspect, a switching means for on-load tap-changers, comprising:
a first fixed contact and a second fixed contact; and
a moving contact with a first attraction element;
wherein:
the moving contact is movable from a first position into a second position via the first attraction element and a second attraction element, which is arranged outside the switching means; and
the moving contact, in its first position, contacts neither or only one of the fixed contacts and, in its second position, contacts both fixed contacts.

The switching means according to the present disclosure is of particularly simple and compact construction. Since the moving contact can be actuated from outside without having to move a moving part outwardly from the interior of the switching means, the entire construction can be realized particularly simply and economically.

In the case of a vacuum interrupter, a moving contact tappet must be sealed at all times by means of a bellows. This is costly, complex and can be easily damaged during the assembly process. The switching means, by contrast, is completely closed and therefore robust and insusceptible. The force required for the actuation of the switching means is independent of the external pressure. The moving contact has a first attraction element. By way of a second attraction element outside the switching means, the moving contact is moved as a result of the second attraction element being brought into the vicinity of the first attraction element. In this case, the moving contact moves, in the interior of the switching means, from a first position into a second position. Here, in the second position the moving contact contacts the two fixed contacts and, in a first position, contacts neither or only one of the fixed contacts. Alternatively, the switching means can also be designed in such a way that, in a first position, the moving contact contacts the two fixed contacts and, in a second position, contacts neither or only one of the fixed contacts. This is dependent solely on whether the switching means is to be embodied as an opener or closer when the second attraction element is brought into the vicinity of the first attraction element.

The switching element can be embodied as a single interrupter or double interrupter. As a double interrupter, the moving contact, in a corresponding first position, contacts neither of the fixed contacts and, in the second corresponding position, contacts both fixed contacts. As a single interrupter, the moving contact is always in contact with one of the fixed contacts or forms a unit with the fixed contact, or the moving contact and one of the fixed contacts are formed in one part. The moving contact in a corresponding first position thus contacts only one of the fixed contacts, and in the second position both fixed contacts. The combination of fixed contact and moving contact is embodied for example as a flexible contact tongue.

The attraction elements can be designed in any desired manner. One of the attraction elements is preferably always embodied as a magnet or as a permanent magnet and the other attraction element is preferably always formed from a soft-magnetic material. Here, the first attraction element is then a magnet and the second attraction element is made of a soft-magnetic material or the first attraction element is made of a soft-magnetic material and the second attraction element is a magnet. Furthermore, both attraction elements can also be designed as magnets or permanent magnets. This is advantageous if the moving contact has to be moved or actuated particularly quickly or with a lot of force.

It may be provided that:
the first attraction element is fastened to the moving contact;
a first spring element is arranged between the moving contact and a second housing part; and
the first spring element holds the moving contact in the first position.

The first spring element may be designed in any desired manner, for example as a compression spring or tension spring. This is always dependent on whether the switching element is designed as an opener or closer and whether or not, upon actuation of the switching element, the moving contact is intended to contact the fixed contacts.

It may be provided that:
a first housing part is provided;
the first and the second housing part form a switching means housing;
the moving contact, the first attraction element and the first spring element are arranged in an interior of the switching means housing; and
the first and the second fixed contact are arranged in such a way that they extend outwardly from the interior of the switching means housing.

The switching means housing may be designed in any desired manner and for example may have a first and a second housing part or also further housing parts. The first and the second housing part are tightly connected to one another for example by adhesive bonding or the like, so that nothing can infiltrate from outside into the interior of the switching means housing.

The fixed contacts may be designed in any desired manner and, for example, may consist of a conductive metal. The fixed contacts are connected to the switching means housing for example by latching or overmolding. The fixed contacts can be designed in one part or in multiple parts.

It may be provided that:
the moving contact and the first attraction element are fastened to a carrier;
the carrier is arranged movably in the switching means housing; and
the switching means housing serves to guide the moving contact or the first attraction element or the carrier during the movement from the first position into the second position.

The moving contact may be designed in any desired manner and for example may form a unit together with the carrier and the first attraction element. During a movement of the moving contact, the carrier and the first attraction element also move. As soon as the moving contact, the carrier, or the first attraction element move, the other parts also move. The carrier can have, for example, a contour or outer form that corresponds at least in part to the contour or the inner form of the switching means housing. At least a part of the switching means housing thus serves as a guide during the movement of the moving contact or the carrier from the first into the second position and/or from the second into the first position. With the aid of a further spring, the moving contact can also be spring-mounted in the carrier, which forms a unit together with the first attraction element.

According to a second aspect, the present disclosure proposes an on-load tap changer with a switch unit, comprising:
a diverter switch bar with a second attraction element.

The on-load tap changer is constructed here particularly simply and during a switch operation uses a switching element with a first fixed contact, a second fixed contact and a moving contact with a first attraction element. The switching element is actuated by means of a second attraction element which is fastened to the diverter switch bar. There is no mechanical connection between the switching element and the diverter switch bar, which simplifies the construction of the on-load tap changer and reduces errors caused by actuation mechanisms. The switching means is actuated indirectly. Costly and sensitive vacuum interrupters, which are usually used in on-load tap changers, can be replaced by the switching means. The on-load tap changer as a whole is thus safer, more economical, and has greater ease of assembly. The switching means of the on-load tap changer is furthermore sealed off from the rest of the insulating oil in the step transformer.

It may be provided that the on-load tap changer has a first selector bar, a second selector bar and a gear unit. The gear unit is designed, during actuation of the on-load tap changer, to move the diverter switch bar in a first direction and a second direction, which is counter to the first direction, in order to actuate the switching means by means of the second attraction element.

It may be provided that:
the first selector bar, the second selector bar and the diverter switch bar are arranged in a collinear manner; and
the gear unit is designed, during a switch operation from a selector contact to an adjacent selector contact, to move the selector bars in a first direction and to move the diverter switch bar, during the switch operation, in the first direction and a second direction, which is counter to the first direction, in order to actuate the switching means.

The gear unit may be designed in any desired manner and may comprise a plurality of drive pinions and also a plurality of output pinions, wherein a drive shaft of the selector bars moves via the drive pinion and the output pinion during the switch operation.

It may be provided that:
the gear unit comprises a crank and a connecting rod, and
the drive shaft moves the diverter switch bar with the second attraction element, via the crank and the connecting rod, and thus actuates the switching means indirectly via the first attraction means during the switch operation of the on-load tap changer.

It may be provided that:
the diverter switch bar comprises a bridge switch, and the gear unit is designed to actuate the bridge switch during the switch operation.

It may be provided that:
the gear unit is designed, during the switch operation, to move the first selector bar in the first direction, then to move the diverter switch bar in the first and the second direction, and then to move the second selector bar in the first direction.

It may be provided that:
the gear unit is designed, during the switch operation, to move the diverter switch bar multiple times in the first and/or multiple times in the second direction; and
the diverter switch bar opens and closes during the switch operation of the switching means.

It may be provided that:
the gear unit is designed as a Geneva gear unit.

It can be provided that the on-load tap-changer has a diverter switch, a selector and a gear unit. The diverter switch is formed here from the diverter switch bar, at least one, but preferably three switching means, three bridge switches and three transition resistors. The selector is formed from the first and the second selector bar. The diverter switch and selector are actuated via the gear unit. All the parts of the selector and of the diverter switch are arranged between two base plates made of insulating material.

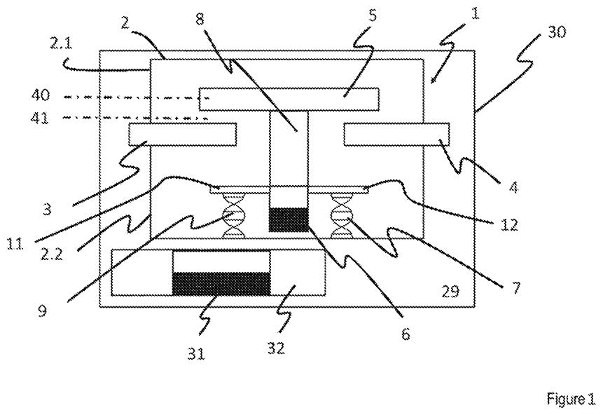

FIG. 1 shows a switching means (switch) 1 according to the present disclosure for an on-load tap-changer 30. The switching means 1 has a switching means housing (switch housing) 2 with a first housing part 2.1 and a second housing part 2.2. Furthermore, the switching means 1 has a first fixed contact 3 and a second fixed contact 4. In the interior 29 of the switching means 1 there is also located a moving contact 5. The moving contact 5 is arranged on or fastened to a carrier 8. Furthermore, a first attraction element 6 is attached to the carrier 8. The moving contact 5, the carrier 8 and the first attraction element 6 form a unit. As soon as one of the parts is moved, the other parts also move. A first spring element 7 and a second spring element 9 are arranged between the carrier 8 and the second housing part 2.2. The spring elements 7, 9 hold the moving contact 5 in a first position 40. In this first position 40, the moving contact 5 contacts neither of the two fixed contacts 3, 4.

A second attraction element 31 is arranged on a diverter switch bar 32. The attraction element 31 and the diverter switch 32 are parts of the on-load tap changer 30. In this case, the switching means 1 and in particular the first attraction element 6 is arranged in the immediate vicinity of the diverter switch bar 32 and thus of the second attraction element 31. The diverter switch bar 32 is mounted movably in the on-load tap changer 30. Upon actuation of the on-load tap changer 30, amongst other things the diverter switch bar 32 is also moved in such a way that the second attraction element 31 is brought into the immediate vicinity of the first attraction element 6 and also can be distanced therefrom again. As soon as the distance between the first attraction element 6 and the second attraction element 31 is small enough and the forces of attraction exceed a certain value, the first attraction element 6 inclusive of moving contact 5 and carrier 8 is moved in the direction of the second attraction element 31. The forces of attraction are great enough here to act against the force of the spring elements 7, 9. The moving contact 5 adopts a second position 41 here in the switching element 1.

In the second position 41, the moving contact 5 contacts neither of the two fixed contacts 3, 4. A current flow through the moving contact 5 and the two fixed contacts 3, 4 is thus made possible. As soon as the diverter switch 32 with the second attraction element 31 moves away from the switching means 1 and in particular the first attraction element 6, the spring elements 7, 9, from a certain point, move the moving contact 5 inclusive of carrier 8 and the first attraction element 6 back into the first position 40. The first position is indicated by a dot-and-dash line.

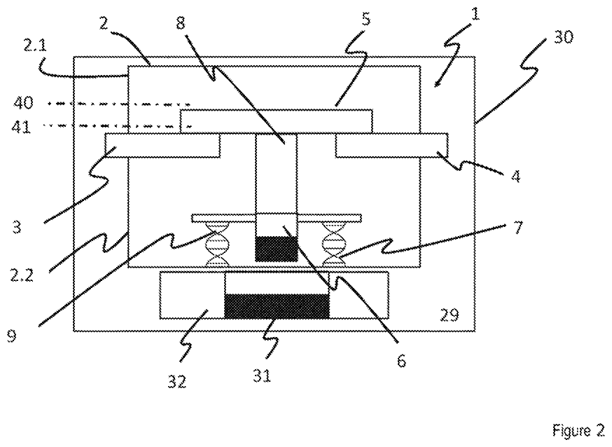

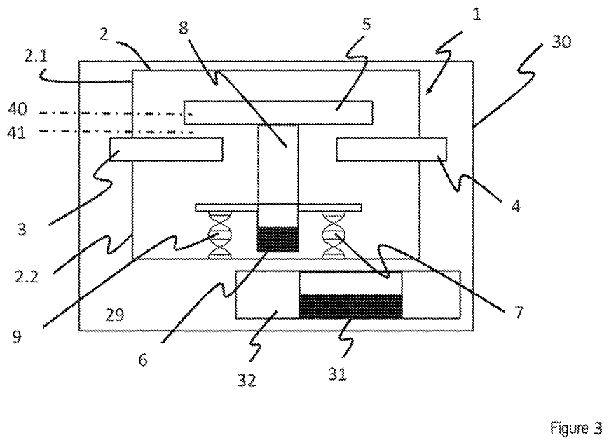

In the embodiment shown here, the diverter switch bar 32 is arranged beneath the switching means 1. The diverter switch bar 32 performs a linear movement in the horizontal plane. As soon as the second attraction element 32 is beneath the first attraction element 6, as shown in FIG. 2, the moving contact 5, as a result of the forces of attraction of the two attraction elements 6, 32, is moved downwards and contact is established between the moving contact 5 and the fixed contacts 3, 4. If the second attraction element 31 moves away from the switching means 1 as a result of the diverter switch bar 32 being moved further in the horizontal, as shown in FIG. 3, the moving contact 5 is driven by the spring elements 7, 9 into the first position 40, and the contact with the fixed contacts 3, 4 is broken. The second position is likewise indicated by a dot-and-dash line.

In the embodiment shown in FIGS. 1-3, the first attraction element 6 and the second attraction element 31 are designed as magnets. Alternatively, only one of the attraction elements 6, 31 can be designed as a magnet, wherein the other attraction element is then designed as a soft-magnetic element. It is irrelevant here whether the first or the second attraction element 6, 31 is designed as a magnet. If both attraction elements 6, 31 are embodied as magnets, the force of attraction between the two attraction elements 6, 31 is particularly strong, which affects the reaction times and movement speeds of the moving contact 5 accordingly.

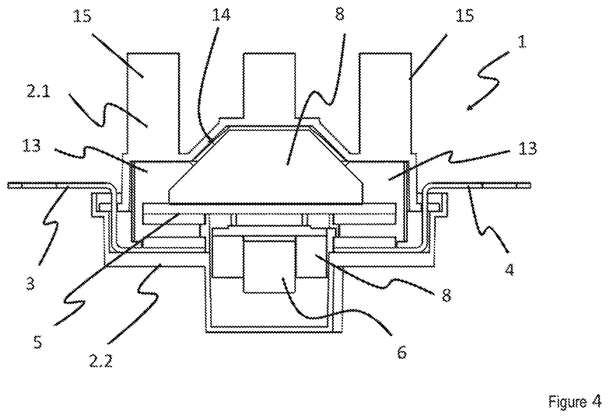

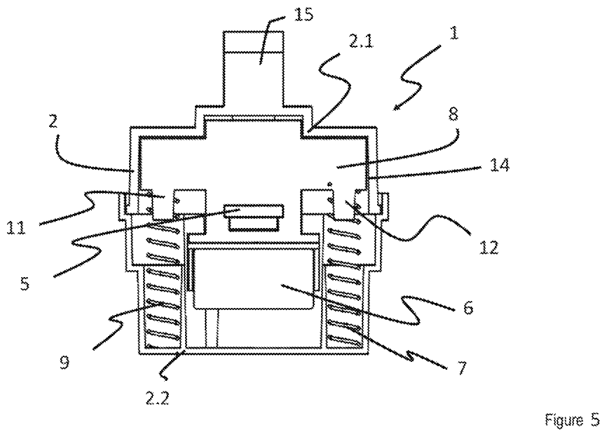

FIG. 4 and FIG. 5 show a structural solution of the switching means 1 according to the present disclosure. Here, the carrier 8 is embodied in such a way that the moving contact 5 and the first attraction element 6 are enclosed by the carrier, so that a unit formed of moving contact 5, first attraction element 6 and carrier 8 is created. The moving contact 5 can be designed in one part or multiple parts. The carrier 8 has contours or outer faces 14, which correspond with the interior of the switching means housing 2 in such a way that a guide is created for the movement of the carrier 8. In other words, a moving and form-fitting connection is created between the housing 2 and carrier 8. Furthermore, the carrier 8 has a first and a second holding element 11, 12, which serve to fix or support the spring elements 7, 9. Spark extinguishing elements 13 are arranged between the respective ends, in particular the contact points, of the moving contact 5 and the fixed contacts 3, 4. The spark extinguishing elements 13 surround the contact faces between the moving contact 5 and the fixed contacts 3, 4 and thus shield the switching means housing 2 from the inside against potential electric arcs. The switching means housing 2 has fastening ribs 15, by means of which the switching means 1 is fixed in the on-load tap changer 30, preferably on a plate. The fixed contacts 3, 4 can be designed in one part or in multiple parts. The contact points between the moving contact 5 and the fixed contacts 3, 4 are made of a material that is particularly resistant to abrasion and wear.

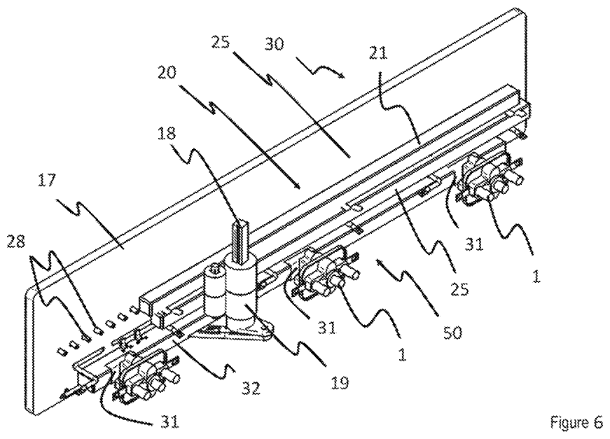

In FIG. 6 the on-load tap changer 30 is shown with a selector 20 and a diverter switch 50. The on-load tap-changer 30 is actuated by means of a drive shaft 18 via a gear unit 19. The selector 20 here comprises a first selector bar 21 and a second selector bar 25. The diverter switch 50 comprises a diverter switch bar 32. Since the shown embodiment of the on-load tap changer 30 is three-phase, the diverter switch 50 has a separate switching means 1 for each phase. The drive shaft 18 moves the first and the second selector bar 21, 25 and also the diverter switch 32 via the gear unit 19. The diverter switch 50 and the selector 20 are arranged on a base plate 17. In addition, a plurality of selector contacts 28 are formed in the base plate 17. The selector contacts 28 are connected to winding taps of a tap winding of a step transformer, in particular local grid transformer.

The gear unit 19 has, in the region of the selector 20, a first and second drive pinion and also a first and second output pinion. Furthermore, the first and the second selector bar 21, 25 each have a toothed region on a side facing the gear unit.

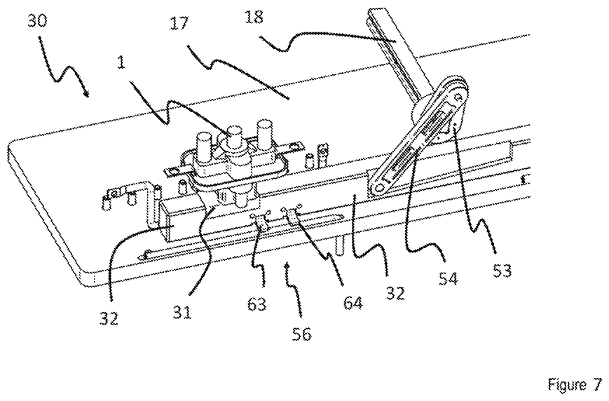

In FIG. 7, the drive shaft 18 is illustrated with a crank 53 and a connecting rod 54. The connecting rod 54 is mechanically connected at a first end to the crank 53 and at a second end to the diverter switch bar 32. By rotating the drive shaft 18, the diverter switch bar 32 is moved via the crank 53 and the connecting rod 54, during the switch operation, in a first direction and in a second direction, which is counter to the first direction. During a switch operation from one selector contact 28 to an adjacent selector contact 28, the selector bars 21, 25 are thus moved in a first direction and the diverter switch bar 32 is moved in the first direction and in the second direction, which is counter to the first direction.

The first selector bar 21 and the second selector bar 25 are arranged in parallel in a plane, the first selector bar 21 and the diverter switch bar 32 are arranged in parallel in a plane, and the second selector bar 25 and the diverter switch bar 32 are arranged in parallel in a plane; this means collinear.

In the event of a switch operation, the selector bars 21, 25 are moved at different times in a first direction, i.e. to the right or to the left or upwards or downwards. The diverter switch bar 32, by contrast, in the event of a switch operation is moved in a first direction and a second direction, which is counter to the first direction, i.e. to the right and to the left, or vice versa, or upwards or downwards, or vice versa.

The diverter switch bar 32, however, may also be moved multiple times in the first or the second direction during a switch operation. The multiple directional changes always occur here after one another.

Furthermore, it is possible to actuate the diverter switch bar 32 via a partially toothed gear unit and/or a Geneva gear unit via the drive shaft 18.

The diverter switch bar 32 has a second attraction element 31 for the actuation of each switching means 1. In the embodiment described here, the diverter switch bar 32 has three attraction elements 31. The attraction element 31 serves to actuate the switching means 1. As soon as the diverter switch bar 32 with the second attraction element 31 enters the effective region of the first attraction element 6, the moving contact 5 is moved into its second position 41 and actuates the switching means 1. Furthermore, the diverter switch bar 32 actuates a bridge switch 56. This comprises a first contact 63 and a second contact 64. The contacts 63, 64 are connected here mechanically to the diverter switch bar 32.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Switching means
2 Switching means housing
2.1 First housing part
2.2 Second housing part
3 First fixed contact
4 Second fixed contact
5 Moving contact
6 First attraction element
7 First spring element
8 Carrier
9 Second spring element
11 First holding element
12 Second holding element
13 Spark extinguishing element
14 Outer faces/contours
15 Fastening ribs
17 Base plate
18 Drive shaft
19 Gear unit
20 Selector
21 First selector bar
25 Second selector bar
29 Interior of 2
30 On-load tap-changer
31 Second attraction element
32 Diverter switch bar
40 First position
41 Second position
50 Diverter switch
53 Crank
54 Connecting rod
56 Bridge switch
63 First contact of 56
64 Second contact of 56

1. A switch for an on-load tap changer, the switch comprising:
fixed contacts comprising a first fixed contact and a second fixed contact; and
a moving contact with a first attraction element;
wherein:
the moving contact is movable from a first position into a second position via the first attraction element and a second attraction element, which is arranged outside the switch; and
the moving contact is configured such that, in the first position, the moving contact contacts neither or only one of the fixed contacts and, in its the second position, the moving contact contacts both of the fixed contacts.

2. The switch as claimed in claim 1, wherein at least one of the first attraction elements or the second attraction element is a magnet or permanent magnet.

3. The switch as claimed in claim 1, wherein:
the first attraction element is fastened to the moving contact;
a first spring element is arranged between the moving contact and a second housing part; and
the first spring element holds the moving contact in the first position.

4. The switch as claimed in claim 1, wherein:
the switch further comprises a first housing part and a second housing part;
the first housing part and the second housing part form a switch housing;
the moving contact, the first attraction element and the first spring element are arranged in an interior of the switch housing; and
the first fixed contact and the second fixed contact are arranged in such a way that they extend outwardly from the interior of the switch housing.

5. The switch as claimed in claim 1, wherein:
the moving contact and the first attraction element are arranged on a carrier and form a unit;
the carrier is mounted movably in a switch housing; and
the switch housing serves as a guide for the carrier during the movement of the moving contact from the first position into the second position.

6. The on load tap changer comprising the switch as claimed in claim 1, the on-load tap changer further comprising:
a diverter switch bar with a second attraction element.

7. The on-load tap-changer as claimed in claim 6, wherein:
the on-load tap-changer further comprising a first selector bar and a second selector bar;
the first selector bar, the second selector bar, and the diverter switch bar are arranged in a collinear manner; and
a gear unit, which is designed:
to move the selector bars, during a switch operation from one selector contact to an adjacent selector contact, in a first direction; and
to move the diverter switch bar, during the switch operation, in the first direction and a second direction, which is counter to the first direction, in order to actuate the switch.

8. The on-load tap changer as claimed in claim 6, wherein:
the gear unit comprises a crank and a connecting rod, and
a drive shaft is configured to move the diverter switch bar with the second attraction element, via the crank and the connecting rod, and thus actuate the switch with the first attraction element during the switch operation of the on-load tap changer.

9. The on-load tap changer as claimed in claim 6, wherein the gear unit is designed such that, during the switch operation, the gear unit moves the first selector bar in the first direction, then moves the diverter switch bar in the first and the second direction, and then to moves the second selector bar in the first direction.

10. The on-load tap changer as claimed in claim 6, wherein the gear unit is designed such that, during the switch operation, the gear unit moves the diverter switch bar multiple times in the first and/or multiple times in the second direction.

11. The on-load tap changer as claimed in claim 6, wherein the diverter switch bar is configured such that, during the switch operation of the on-load tap changer, the diverter switch bar opens or closes the switch.
